(19) United States
(12) Patent Application Publication
(10) Pub. No.: US 2023/0077807 A1
(43) Pub. Date: Mar. 16, 2023

(54) DYNAMICALLY CONFIGURING AN ENERGY CONSUMING SYSTEM TO IMPROVE ENERGY EFFICIENCY

(71) Applicant: Accenture Global Solutions Limited, Dublin (IE)

(72) Inventors: Vivek Chidambaram, Houston, TX (US); Rami El Debs, Houston, TX (US); Thomas James Beswetherick, Santa Monica, CA (US); David Arguelles Elizondo, Houston, TX (US); Lasse Kari, Düsseldorf (DE); Christopher Kyle Gardner, Austin, TX (US); Manas Ranjan Satapathy, Houston, TX (US); Varun Bindal, Calgary (CA); Akrit Kaur, Richmond, TX (US)

(21) Appl. No.: 17/942,519

(22) Filed: Sep. 12, 2022

Related U.S. Application Data
(60) Provisional application No. 63/242,632, filed on Sep. 10, 2021.

(51) Int. Cl. H02J 3/14; H02J 3/00

(52) U.S. Cl. CPC H02J 3/144; H02J 3/003; H02J 3/004

(57) ABSTRACT

Example computer-implemented methods, media, and systems for configuring an energy consuming system are described. One example computer-implemented method includes receiving, for each type of energy of multiple types of energy, data defining a set of parameters related to a capacity of the type of energy for a particular region. The capacity for each type of energy is converted into a common unit of energy using the set of parameters for each type of energy. A determination is made, by evaluating a model using at least on the capacity of two o1r more of the types of energy and a required amount for each of the two or more types of energy, an operational adjustment to one or more components of an energy consuming system that adjusts energy consumption of the one or more components. The one or more components are reconfigured according to the operational adjustment.

### CROSS-REFERENCE TO RELATED APPLICATION

This application claims the benefit of U.S. Provisional Application No. 63/242,632, filed Sep. 10, 2021, and titled “Improving Energy Efficiency,” which is incorporated herein by reference.

### FIELD

This specification generally relates to improving energy efficiency.

### BACKGROUND

The combination of limited energy resources and a highly heterogeneous world, along with a drive to reduce or eliminate carbon emissions is leading to a multipolar energy system rather than a homogeneous energy system dominated by hydrocarbons.

### SUMMARY

This specification generally describes systems and techniques for controlling the operation of an energy consuming system, e.g., an industrial facility or hybrid vehicle, that is capable of consuming energy produced by multiple types of energy sources to improve one or more objectives, such as increased energy efficiency, reduced carbon emissions, and/or increased productivity or performance. Controlling the operation of an energy consuming system can include, for example, selecting an energy source based on current conditions, selecting an output of the energy consuming system e.g., a product being produced by the energy consuming system, selecting machines or other components to activate or run within the system, configuring how these components run and from where these components obtain resources used by the components, determining whether to use carbon capture technology to reduce carbon emissions, and/or other appropriate actions depending, for example, on the type of the energy consuming system.

A system configuration device can configure the energy consuming system based on various inputs and objectives. These inputs can include, for example, operational data for the system, historical data related to the system, carbon intensity (e.g., emissions) data, an energy system curve that represents the availability of various types of energy resources (e.g., within the same geographic region as the system) and the efficiency in utilizing the various types of energy resources by the system. Such data comes in many formats and the system configuration device can be configured to process the data to place all input data into a common machine processable format that can be evaluated using one or more modules to generate outputs that control operation of the energy consuming system based on the reformatted inputs.

The system configuration device can generate the energy system curve by converting the supply of and/or demand for each type of energy resource into a common energy measurement unit, e.g., joules or gigajoules. However, such conversion is non-trivial as converting an available of supply of various types of energy resources can require the evaluation of many factors, such as weather in a region (e.g., for solar panels and wind turbines), the ability to place energy conversion devices in the region, local regulations related to energy, and/or other factors.

In general, one innovative aspect of the subject matter described in this specification can be embodied in methods that include the actions of receiving, for each type of energy multiple types of energy, data defining a set of parameters related to a capacity of the type of energy for a particular region; converting, using the set of parameters for each type of energy, the capacity for each type of energy into a common unit of energy; determining, by evaluating a model using at least on the capacity of two or more of the types of energy and a required amount for each of the two or more types of energy, an operational adjustment to one or more components of an energy consuming system that adjusts energy consumption of the one or more components; and reconfiguring the one or more components according to the operational adjustment. Other embodiments of this aspect include corresponding systems, apparatus, and computer programs, configured to perform the actions of the methods, encoded on computer storage devices.

These and other implementations can each optionally include one or more of the following features. In some aspects, the common unit of energy is joules.

Some aspects include generating an energy system curve that represents the capacity of each type of energy of a set of types of energy for the particular region and, for each type of energy, a relationship between invested capital turnover for the type of energy that can be achieved per unit currency and net profit margin for the capacity of the type of energy. The model can be based on the energy system curve.

In some aspects, the operational adjustment includes switching from a first energy source to a second energy source for providing energy to at least one of the one or more components. In some aspects, the set of parameters for each type of energy differs from the set of parameters for each other type of energy.

In some aspects, reconfiguring the one or more components includes operating a first component of the energy consuming system based on the type of energy selected for a second component of the energy consuming system. In some aspects, the model includes a set of modules configured to determine output parameters that define the operational adjustment to the one or more components. The model can determine the output parameters based on at least one objective for the model. The at least one objective can include at least one of minimizing carbon emissions, maximizing margin, maximizing production, or maximizing production without exceeding a carbon emission threshold.

In some aspects, the operational adjustment includes a selection of a component from a set of components of the energy consuming system. The operational adjustment can include a selection of a product to be produced by the energy consuming system.

According to some implementations, a method includes receiving, for each type of energy of multiple types of energy, a capacity of the type of energy for a particular region. The capacity for each type of energy is converted into a common unit of energy. A determination is made, by evaluating a model that is based at least on the capacity of two or more of the types of energy and a cost of each of the two or more types of energy, about an operational adjustment to an energy consuming unit that adjusts energy consumption of the energy consuming unit. The energy consuming unit is reconfigured according to the operational adjustment.

Implementations may include one or more of the following features. In some aspects, the common unit of energy is joules. The method can include generating an energy system curve that represents the capacity of each type of energy for the particular region and, for each type of energy, a relationship between invested capital turnover for the type of energy that can be achieved per unit currency and net profit margin for the capacity of the type of energy. The model can be based on the energy system curve. The operational adjustment can include switching from a first energy source to a second energy source.

The methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features, aspects, and advantages of the subject matter will become apparent from the description, drawings, and the claims.

### BRIEF DESCRIPTION OF THE DRAWINGS

FIG. 1 depicts an example environment in which a system configuration device controls the operation of an energy consuming system.

FIG. 2 depicts a graph of an example energy system curve.

FIG. 3 depicts an example system configuration engine.

FIG. 4 depicts an example interactive user interface generated and displayed by a system configuration device.

FIG. 5 depicts another example interactive user interface generated and displayed by a system configuration device.

FIG. 6 depicts an example process for reconfiguring one or more components of an energy consuming system.

FIG. 7 depicts an example computer system that can be used to execute implementations of the present disclosure.

Like reference numbers and designations in the various drawings indicate like elements.

### DETAILED DESCRIPTION

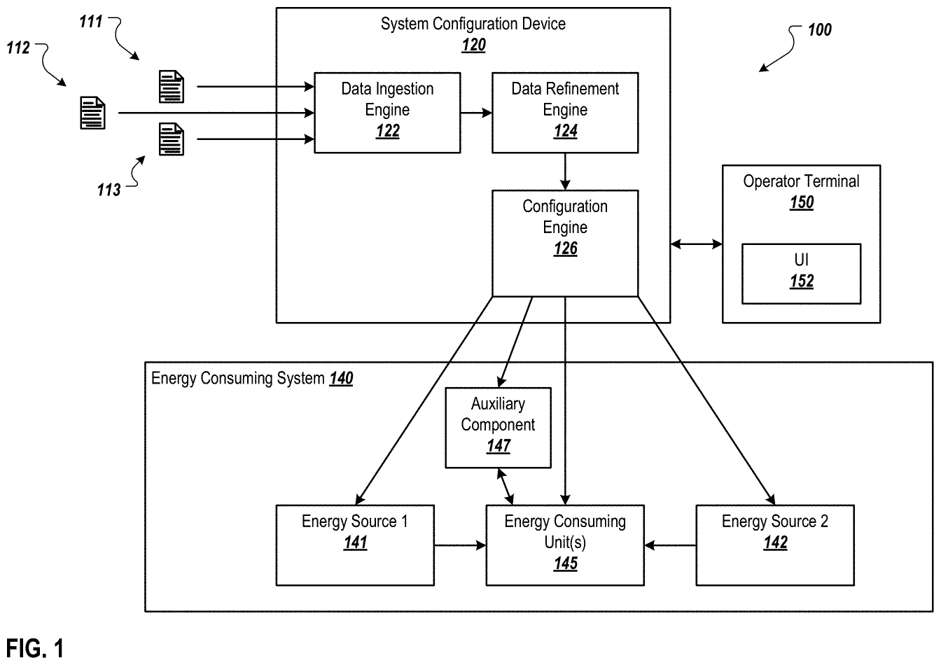

FIG. 1 depicts an example environment 100 in which a system configuration device 120 controls the operation of an energy consuming system 140. The system configuration device 120 can also be referred to as an energy selection system as it is configured to adjust energy use of an energy consuming unit 145 of the energy consuming system 140, in addition to being capable of controlling operation of the energy consuming unit 145 and/or other components of the energy consuming system 140. The system configuration device 120 can be implemented as one or more computers located in one or more locations, e.g., at the same location as the energy consuming system 140 or a different location, e.g., in the cloud.

The energy consuming system 140 can be a factory, plant, building, vehicle that can operate on different types of energy sources (e.g., solar, battery, and/or gasoline), or other industrial, commercial, residential or other type of system or device that is capable of consuming different types of energy sources. The system 140 can include energy consuming unit 145that are powered by multiple different energy sources, e.g., energy sources 141 and 142. Although two energy sources 141 and 142 are shown in FIG. 1, various other numbers of energy sources can be used to provide power to the energy consuming unit 145. Similarly, the system 100 can include many energy consuming units 145.

The system 140 can also include auxiliary components, such as auxiliary component 147 that support the energy consuming unit(s) 145. Each auxiliary component 147 can be powered by one or more energy sources, e.g., energy sources 141 and/or 142. For example, the system 140 can be an oil extraction facility that extracts oil from oil sands. The facility may need to generate steam to produce the oil. Multiple different steam generators can be used to produce the steam and each steam generator can use a different type of energy to produce the steam, or at least some steam generators use a different type of energy to produce steam than others. In this example, each steam generator can be an energy consuming unit 145 that is powered by different energy sources 141 and 142, e.g., one power by burning oil, one powered by burning natural gas, one powered using solar panels, and/or one powered using wind energy from a wind turbine. The oil extraction facility can also include auxiliary components 147, such as water treatment plants, that may be configured based on which steam generators are running and/or how much steam is being produced by the steam generators.

The system configuration device 120 can perform functions that improve energy efficiency and/or other objectives related to energy consumption, such as reducing carbon emissions, reducing expenses, conserving certain types of energy, etc. For example, the system configuration 120 can evaluate a set of input parameters to reconfigure the energy consuming system140, e.g., by selecting between multiple energy sources to drive components of the energy consuming system 140. Continuing the oil extraction facility example, the system configuration device120 can select the steam generator based on the input parameters and operate the steam generators accordingly. For example, the system configuration device 120 can activate the selected steam generator and deactivate the non-selected steam generator. The system configuration device 120 also control operation of the water treatment plant based on the selected steam generator, e.g., to output more or less water depending on the water usage of the selected steam generator.

The system configuration device 120 can receive input data 111-113 from various sources. One example input is the energy capacity and utilization of a particular type of energy in a particular region, e.g., a particular geographic region. The capacity of the types of energy can be expressed in different ways. For example, the capacity of oil can be expressed in the number of barrels, or the number of barrels per day, which can be based on the well delivery of an oil well. The capacity of solar energy can be expressed in terms of the number of solar panels available, their efficiency, and the number of hours of sunlight per day in the particular region, which varies throughout the year. Other capacity related data can include a capacity factor, plant uptime for a power plant, and pipeline for a natural gas or other fuel pipeline.

Another example input is the cost of each type of energy, e.g., gas price, oil price, etc. As this information can vary over time, this information can be updated regularly, e.g., each day, each hour, each week, or based on another appropriate time period.

Another example input is predictions as to the future capacity of each type of energy in the particular region, predictions as to the future cost of each type of energy, and/or capital costs to achieve the future capacity (e.g., the cost to install solar panels or wind farms with wind turbines. Another example input is information about the carbon emissions of each type of energy. This can include the type of emissions, e.g., methane, combustion, flaring, etc., the cost of the emissions or the cost of offsetting the emissions in the particular region, and/or the expected amount of carbon emissions. This information can also include current and/or expected future regulations related to carbon emissions in the region.

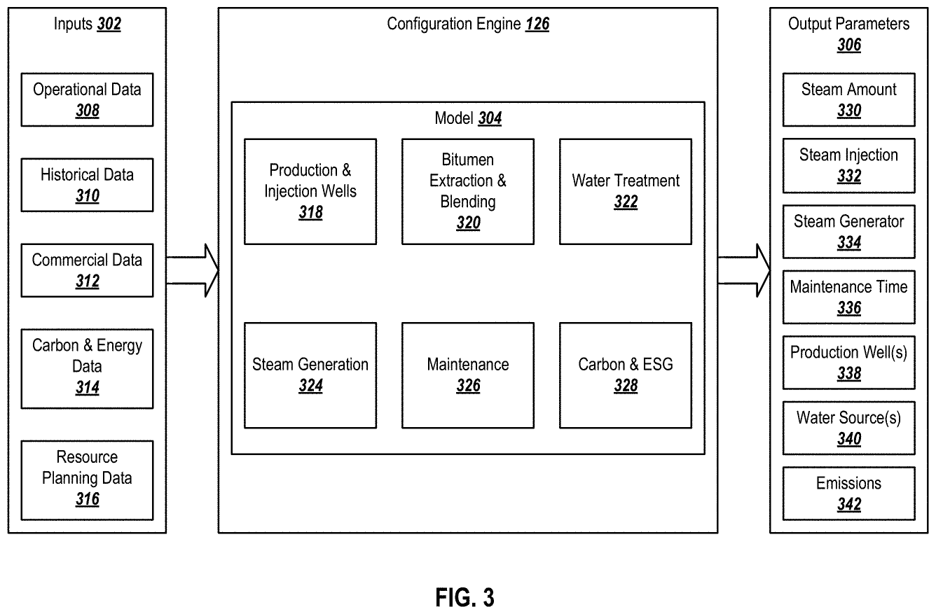

Some other example inputs can be specific to the energy consuming unit 140. The information can include operational data, financial data, historical data, etc. This data can include data related to the amount of energy consumed for various operational levels and/or durations at the levels, the maintenance of the system 140 and/or its individual components (e.g., energy consuming units 145 and/or auxiliary components 147) required for each operational level and/or duration at the level, operational schedules, maintenance costs, etc. Some example types of input data 111-113 are also illustrated in FIG. 3 and described below.

The system configuration device 120 includes a data ingestion engine 122, a data refinement engine 124, and a configuration engine 126. The data ingestion engine 122 obtains the input data 111-113 from the various data sources and provides the raw data to the data refinement engine 124. The data ingestion engine 122 can periodically request data from the various sources and/or receive pushed data from the sources periodically.

The data refinement engine 124 formats and/or refines the raw data so that the data can be processed by the configuration engine 126. Each data source can package data in different non-standard formats. For example, the data ingestion engine 122 can retrieve energy cost data from a dynamically updated website multiple times per day by crawling the website or obtaining a webpage document, e.g., HTML document. Another data source may provide capacity data in a text file that has to be parsed to obtain capacity for each of multiple types of energy sources. The data refinement engine 124 can be configured to parse the various formats and generate one or more data files and/or update a data structure with each type of data in a standard format that can be processed by the configuration engine 126.

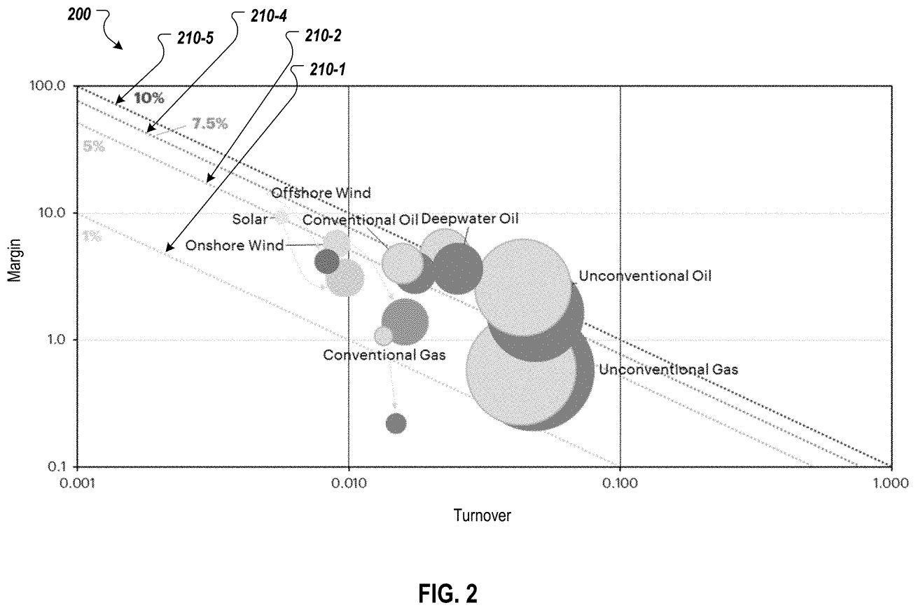

The configuration engine 126 can evaluate the input data and perform actions that affect the consumption of energy by the energy consuming unit 145 and/or other components of the system 140 based on the evaluation. The configuration engine 126 can also perform actions that control operation of the energy consumption unit 145 and/or other components, e.g., auxiliary components 147, of the system 140. One type of data that the configuration engine 126 can consider is an energy system curve that represents the capacity of various types of energy, e.g., in a particular region, and, for each type of energy, the invested capital turnover, e.g., the amount of capacity for the type of energy that can be achieved per unit currency (e.g., per U.S. Dollar (USD), and the net profit margin for the capacity of the type of energy. An energy curve can represent these parameters for a specific geographic region (e.g., a continent, state, city, hemisphere, etc.) or globally. The capacity can be represented in gigajoules (GJ). An example energy system curve is shown in FIG. 2 and described below. The data refinement engine 124 can generate and update the energy system curve periodically, for example, annually, monthly, or based on another appropriate time period, e.g., depending on performance of different assets, emissions, global tax regime, regulatory landscape, and/or new technologies.

To produce the energy system curve, the data refinement engine 124 can convert the capacity data for each type of energy, e.g., each energy source, to a common unit. For example, the types of energy can include solar, wind, various types of oil (e.g., deepwater oil, shale oil, etc.), conventional natural gas, unconventional natural gas, unconventional oil, hydroelectric energy, nuclear, coal, geothermal, fusion, and/or other appropriate types of energy. In the example of FIG. 2, the data refinement engine 124 converts the capacity of each type of energy to the total amount of joules that can be produced using the type of energy per unit time, e.g., the number of joules per year. This enables an accurate comparison between capacities, profitability, and invested capital turnover for the different types of energy. In this example, the energy system curve can be referred to as an energy joule curve.

The data refinement engine 124 can use various parameters to determine the capacity of each type of energy, the margin for each type of energy, and the turnover for each type of energy, and the parameters can differ between the different types of energy. For example, the data refinement engine 124 can determine the capacity of wind energy in a geographic region based on wind patterns in the region, the available land for wind turbines, regulations related to the deployment of wind turbines in the region, and/or other appropriate parameters. In contrast, the data refinement engine 124 can determine the capacity for deepwater oil in the region based on current drilling capacity in the region, estimates of additional drilling capacity in the region, regulations and permitting requirements in the region, and/or other appropriate parameters.

The data refinement engine 124 can also use different parameters for the different types of energy to determine the margin and/or turnover for each type of energy for the energy system curve. For example, the margin and turnover for wind and solar energy can be based on maintenance strategies, placement of the solar cells or wend turbines, land costs, permit costs, technology selection, wind turbine and solar panel size selection, etc. In contrast, the margin and turnover for deepwater oil can be based on drilling costs, permit costs, well design for new wells, carbon emissions costs, and other appropriate parameters.

As there are many parameters used to determine the capacity, margin, and turnover represented by an energy system curve and these parameters vary from region to region, it can be difficult to accurately generate energy system curves. The data refinement engine 124 can be configured to evaluate the parameters for each type of energy using the various input data, e.g., using a set of rules, equations, and/or machine learning models, to generate each energy system curve.

FIG. 2 depicts a graph of an example energy system curve 200. The energy system curve 200 depicts the capacity of each of multiple types of energy using circles such that larger circles represent larger capacities. The energy system curve 200 also shows the margin (e.g., USD/GJ) versus the turnover on investment (e.g., GJ/USD) for each type of energy. The energy system curve 200 also includes isovalue lines 210-1 through 210-5 that represent where the total return on capital investment is the same for each type of energy is the same.

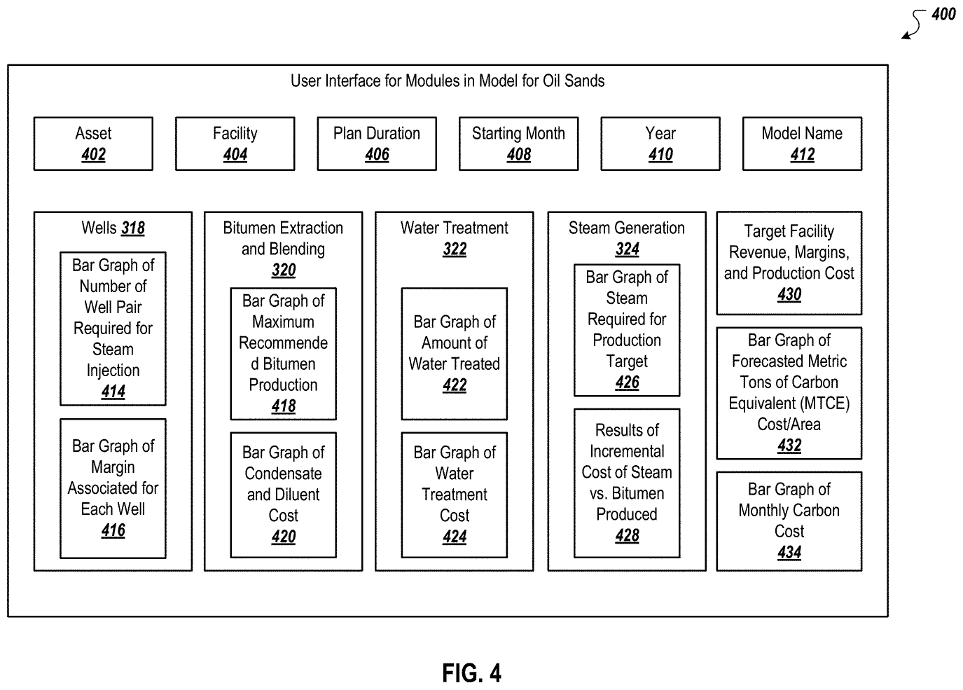

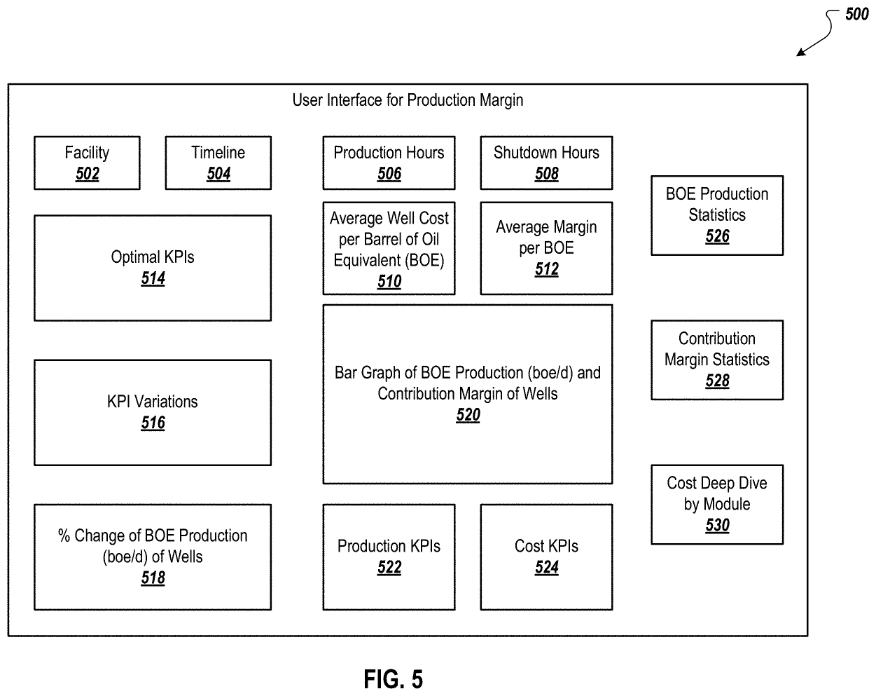

Referring back to FIG. 1, the configuration engine 126 can analyze the energy system curve 200 and other input data to make operational decisions for the energy consuming unit 145, any auxiliary components 147 of the system 140, and/or other resources of the system 140. For example, the energy system curve 200 can be used to allocate resources for developing energy sources for future operations of the energy consuming system 140 and its various components and resources. In a particular, example, the configuration engine 126 can use the energy system curve 200 to determine that there will be sufficient capacity of wind energy and that, based on carbon emission costs, the cost of adding wind turbines to replace or supplement current carbon-based energy sources for the system 140 is an efficient use of capital and/or other resources. In response, the configuration engine 126 can update a user interface 152 of an operator terminal 150 to indicate that wind turbines should be built for the system 140. Other interactive user interfaces that can be generated and displayed by the operator terminal 150 are illustrated in FIGS. 4 and 5 and described below.

The configuration engine 126 can also use the energy system curve and other data described herein to make daily, weekly, hourly, or real-time operations decisions for the energy consuming system 140. The configuration engine 126 can use a model to maximize (or at least improve) one or more objectives based on the data and these objectives can vary based on the types of energy available for consumption by the energy consuming system 140 and/or the operations of the energy consuming system 140.

Some example objectives for the model can include, for example, maximizing production (e.g., maximizing the amount of product produced independent of costs or carbon emissions), maximizing margin (e.g., maximize margin independent of the amount of product produced or emissions), and maximizing margin within a carbon emission threshold (e.g., produce the maximum amount of product without exceeding a threshold amount of carbon emissions for the system 140). Other objectives can include minimizing carbon emissions (e.g., produce products using the least amount of carbon possible), maximizing energy efficiency, or maximizing use of green or non-carbon energy resources while still producing a certain amount of product. Although products are used in the examples, products can be replaced with other production or performance goals, such as transporting people in hybrid vehicles.

The model can be implemented in various different forms. In some example, the configuration engine 126 trains and uses one or more machine learning models to determine operating parameters for the system 140 that achieves (or at least best approaches) the objectives. In another example, the model can be a rule-based model that evaluates a set of rules to determine the operating parameters for the system 140 that achieves (or at least best approaches) the objectives.

In general, the model can evaluate, as inputs, operational data for the system 140, historical data for the system 140, commercial data for the system 140, carbon and energy data for the system 140, resource planning data for the system 140, and the energy system curve for the region in which the system 140 is located. Some examples of these types of input data are described with reference to FIG. 3. For example, the model can consider, as inputs, the current cost of each type of energy, the capacity of the type of energy available to the energy consuming system 140, the energy system curve for the region in which the system 140 is located, the effects of using each type of energy, e.g., the maintenance caused by using the type of energy, the amount/cost of carbon emissions produced using the type of energy, and/or other appropriate parameters.

To illustrate, consider an oil extraction facility that extracts oil from oil sands. This facility can generate steam, potentially from multiple steam sources that use different types of energy to produce the steam, in order to extract oil. The model for such a facility can have, as objectives, increasing oil extraction, minimizing maintenance costs, minimizing energy consumption costs, maximizing margin on the extracted oil, reducing carbon emissions and associated costs, and/or maximizing margin on the extracted oil without exceeding a maximum carbon threshold for the facility. The configuration engine 126 can evaluate the model using the various inputs to determine when to produce steam to extract oil and, if so, which energy source to use to produce the steam. For example, if the cost of oil is high, the capacity of an energy source for producing steam is high with a low cost, the configuration engine 126 can determine to produce steam using that energy source to extract oil. The configuration engine 126 can also control other components of the facility, such as water treatment plants based on the selected energy source for producing the steam.

The configuration engine 126 can provide a user interface 152, e.g., a dashboard user interface, that enables a user, e.g., an operator, to adjust the objectives or the weights of the objectives of the model if the model includes weights. For example, a user may want to reduce maintenance costs for a particular period of time. In such cases, the configuration engine 126 can determine how often and/or when to produce steam to extract oil, while balancing the other objectives, e.g., to produce a certain amount of oil. The configuration engine 126 can then control the various components of the oil extraction facility based on the output of the model.

To control components of the system 140, the system configuration device 120 can be communicably coupled to each component, e.g., to energy consuming unit(s) 145, energy sources 141 and 142, auxiliary component(s) 147. For example, the device 120 can be communicably coupled to the components using wired or wireless interfaces.

In some implementations, the configuration engine 126 can be configure to output recommendations for controlling the components of the system 140 at a user interface 152 or the operator terminal 150. An operator can view the recommendations and control the components accordingly.

FIG. 3 illustrates an example configuration engine 126 for an oil extraction facility. The configuration engine 126 can evaluate one or more models 304 based on inputs 302 to generate output parameters 306 for controlling components of the system 140. The model 304 can be configured to generate the output parameters 306 such that they achieve one or more objectives, which can be user-selected objectives, as described above. For example, the objectives can include increasing oil extraction, minimizing maintenance costs, minimizing energy consumption costs, maximizing margin on the extracted oil, reducing carbon emissions and associated costs, and/or maximizing margin on the extracted oil without exceeding a maximum carbon threshold for the facility.

In this example, the model 304 includes a set of modules 318-328 for determining the output parameters for different components of the oil extraction facility. The module 318 is configured to select the production wells and the wells where produced steam is injected based on the inputs 302 and the objectives. The module 320 is configured to determine the amount of bitumen to be extracted from oil sands and blended based on the inputs 302 and the objectives. The module 322 is configured to determine how water treatment is performed, including where to source water, how to treat the water, and/or to which steam generator to route the water based on the inputs 302, the objectives, and the selected steam generator(s). The module 324 is configured to determine the amount of steam to be generated for injection into wells and/or which steam generator(s) to use to generate the steam based on the inputs 302 and the objectives. The module 326 is configured to determine when to perform maintenance on components of the oil extraction facility based on the inputs 302 and the objectives. The module 328 is configured to determine carbon emission and/or environmental, social, and governance (ESG) costs associated with the operations of the oil extraction facility according to parameters being considered for the facility. These costs can be updated for multiple iterations of the model until a configuration of parameters is found that maximizes the objectives based on the inputs 302.

Each module 318-328 can be implemented as a set of rules or as a machine learning model. The model 304 can also include different or other modules for facilities in industry sectors other than oil extraction from oil sands, and can be retuned when used to maximize objectives of those facilities.

As illustrated in FIG. 3, the inputs 302 to configuration engine 126 can include operational data 308, data historian 310, commercial data 312, carbon intensity and energy data 314, and financial data 316 such as data from enterprise resource planning (ERP) systems. In some implementations, operational data 308 can include production data by component of the facility. The production data can include the amount of product (or other item) that can be produced by each component of the facility per unit time. The operational data can also include the production of each component based on the type of energy used to power the component. For example, using one type of steam generator to produce steam for extracting oil may result in more oil production than the use of another type of steam generator.

Commercial data 312 can include current energy prices, energy price forecasts, and/or taxation forecasts (e.g., for carbon emissions). Carbon intensity and energy data 314 can include the energy system curve produced by data refinement engine 124, e.g., the example energy system curve 200 illustrated in FIG. 2, where the common unit of energy is joules for each energy source shown in FIG. 2. Carbon intensity and energy data 314 can also include emissions data (e.g., the amount of carbon emitted by each component of the facility) and energy consumption data for each component of the facility. This data can be broken down by levels of operation, e.g., how much carbon is produced at each production level and how much energy is consumed at each production level. Resource planning data 316 can include data such as overall cost data (capital expenditure (CAPEX), operating expenses (OPEX), etc.), cost data per component, and financial models for alternative technologies by process (e.g., breakeven model for heating with electricity in iron or furnaces). The resource planning data 316 can also include data related to the maintenance of the components at the facility. For example, the data can include data related to the impact of using each component at each production level on the maintenance schedule for the component.

As illustrated in FIG. 3, the output parameters 306 can include the selections of energy sources, configurations of equipment at the facility and its operation, and the selection of product to output at the facility. In particular, the output parameters 306 can include the steam amount 330, which can be the amount of steam to produce for a period of time to extract oil. The output parameters 306 also include steam injection data 332, which can indicate where to inject the steam, e.g., into which wells to produce various blends of oil. The output parameters 306 also include steam generator data 334 that indicates which steam generator(s) to use to produce the steam. For example, some steam generators may use different types of energy and the configuration engine 126 can select the steam generator(s) based on the appropriate type of energy for achieving the selected objective(s).

The output parameters 306 can also include maintenance time data 336 that indicates when to perform maintenance on one or more components of the facility. The output parameters 306 also include production well data 338 that indicates from which production wells oil is to be extracted. The output parameters 306 also include water source data 340 that indicates from which water sources water should be obtained for the steam generators or other components of the facility. This can also include control parameters for water treatment plants at the facility, e.g., to pull water from the appropriate source and to provide water to the appropriate steam generator. The output parameters 306 also include emissions data that indicates a cost of carbon emissions that may be incurred if the facility is operated per the output parameters 306.

The output parameters can be displayed to an operator so that the operator can approve the output parameters and/or configure the components of the facility according to the parameters. The configuration engine 126 can also send control information to components of the facility to control the components in accordance with the output parameters.

The configuration engine 126 can evaluate the model to generate updated output parameters 306 continuously, periodically, or based on another appropriate schedule. For example, the facility may run on a set production schedule and the configuration engine 126 can evaluate the model before each production event to generate output parameters for the production event. In another example, an operator can initiate the evaluation of the model by selecting one or more objectives using a user interface.

Although the example inputs 302, modules 318-328, and output parameters 306 are specific to an oil extraction facility, similar inputs, modules, and output parameters can be used for other types of energy consuming systems 140. However, as each system includes different components and produce different products or achieve different goals, the various inputs, modules, and output parameters can vary from system to system. Thus, the model and modules of the model can be updated to fit the various different systems at which the model is deployed.

FIG. 4 illustrates an example interactive user interface 400 generated and displayed by the system configuration device 120 of FIG. 1. User interface 400 includes interactive user interface elements 402-412 that enable a user, e.g., an operator, to provide input parameters for the modules of a model, e.g., the model 304 of FIG. 3, to generate output parameters, e.g., the output parameters 306, such that they achieve one or more objectives for a facility. These user interface elements include an asset element 402 for selecting an asset (e.g., component of the facility) to view information and/or configure manually, a facility element 404 for selecting a facility or portion of a facility to view information and/or configure manually, a plan duration element 406 for selecting a duration for which information is displayed by the user interface 400, a starting month element 408 for selecting a starting month for which information is displayed by the user interface 400, a year 410 element for selecting a year for which information is displayed by the user interface 400, and a model element 412 that enables a user to select from multiple models for use in configuring components of the facility to achieve one or more objectives for the facility.

The example modules shown in FIG. 4 include production and injection wells module 318, bitumen extraction and blending module 320, water treatment module 322, and steam generation module 324 of FIG. 3. For each module in user interface 400, bar graphs and/or curves representing the corresponding output parameters and/or performance metrics are displayed by the user interface 400. For example, the displayed output parameters and metrics for the production and injection wells module 318 include a bar graph of number of well pair required for steam injection 414 and bar graph of margin associated for each well 416. The displayed output parameters and metrics for the bitumen extraction and blending module 320 include a bar graph of maximum recommended bitumen production 418 and bar graph of condensate and diluent cost 420. The displayed output parameters and metrics for the water treatment module 322 include a bar graph of amount of water treated 422 and a bar graph of water treatment cost 424. The displayed output parameters from steam generation module 324 include bar graph of steam required for production target 426 and results of incremental cost of steam vs. bitumen produced 428. User interface 400 can also display inputs and/or other parameters used by model 304, such as target facility revenue, margins, and production cost 430, bar graph of forecasted metric tons of carbon equivalent (MTCE) cost/area 432, and bar graph of monthly carbon cost 434.

FIG. 5 illustrates another example interactive user interface 500 generated and displayed by the system configuration device 120 of FIG. 1. In general, this user interface 500 displays performance and other metrics for a facility, e.g., an oil extraction facility. User interface 500 shows a bar graph of barrels of oil equivalent (BOE) production and contribution margin of wells 520 the production margin of each well within a region as projected by model 304 of FIG. 3, given the input parameters and/or assumptions of the modules shown in user interface 400. User interface 500 can also show other output parameters from model 304 of FIG. 3, such as facility 502, timeline 504, production hours 506, shutdown hours 508, average well cost per BOE, and average margin per BOE. Optimal KPIs 514 and KPI variations 516 can also be displayed by user interface 500. These KPIs can include total BOE, revenue, well cost, and margin. User interface 500 can also display percentage change of BOE production of wells 518. Other displayed output parameters can include production KPIs 522 and cost KPIs 524. Example production KPIs can include BPE production, gas production, oil production, emulsion production, and gas to oil ratio (GOR). Example cost KPIs can include contribution margin, free cash flow, non-recurring cost, recurring fixed cost, recurring variable cost, and well cost. User interface 500 can also show BOE production statistics 526, contribution margin statistics 528, and cost deep dive by module 530.

The user interfaces 400 and 500 of FIGS. 4 and 5 are examples of user interfaces that can be generated by a system configuration device 100 and that enable users to use various models to improve the energy efficiency and other measurable objectives for an energy consuming unit. Various other arrangements of metrics, graphs, user interface controls, and so on can also be used. For example, other types of graphs can be used in place of bar graphs and other metrics can be displayed, e.g., for different types of energy consuming systems.

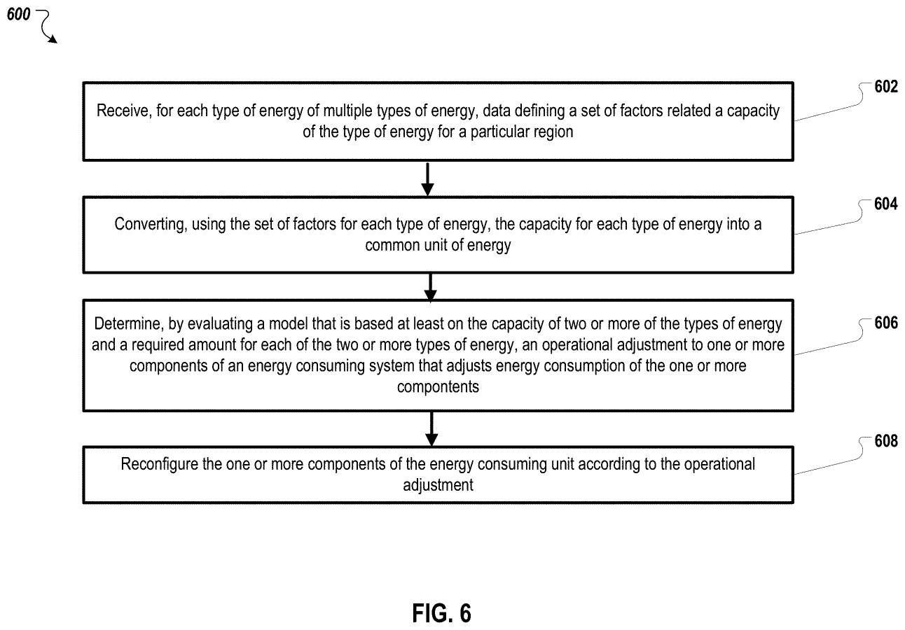

FIG. 6 illustrates an example process 600 for adjusting energy use of an energy consuming unit. The process 600 can be performed by the system configuration device 120 of FIG. 1, which can be implemented using one or more computers. For convenience, the process 600 will be described as being performed by a system of one or more computers, located in one or more locations, and programmed appropriately in accordance with this specification.

The system receives, for each type of energy of multiple types of energy, data defining a set of parameters related to a capacity of the type of energy for a particular region (602). For example, there may be many types of energy available in a geographic region, including oil, natural gas, solar, wind, geothermal, nuclear, etc. The system can receive the data from various input sources, as described above and reformat the data into a standard format. The set of parameters can also vary for the different types of energy, as described above.

The system converts, using the set of factors for each type of energy, the capacity for each type of energy into a common unit of energy (604). The system can determine the capacity of each type of energy source in terms of the common unit of energy using the parameters for that type of energy. In some implementations, the common unit is joules or gigajoules.

The system determines an operational adjustment to one or more components of an energy consuming system that adjusts energy consumption of the one or more components (606). The system can determine the operational adjustment by evaluating a model that is based at least on the capacity of two or more of the types of energy and a required amount, e.g., cost, for each of the two or more types of energy. As described above, the model can be a machine learning model or a rule-based model.

The operational adjustment can include selecting, from multiple available energy sources, an energy source for a component or selecting a component for use in running the system based on the energy source that the component uses, and then activating or using the component. The operational adjustment can be reconfiguring operation of a component, e.g., to support another component that is selected based on its energy source.

The system reconfigures the one or more components according to the operational adjustment (608). For example, the system can send, to each component, data that causes the component to operate in accordance with the operational adjustment determined using the model.

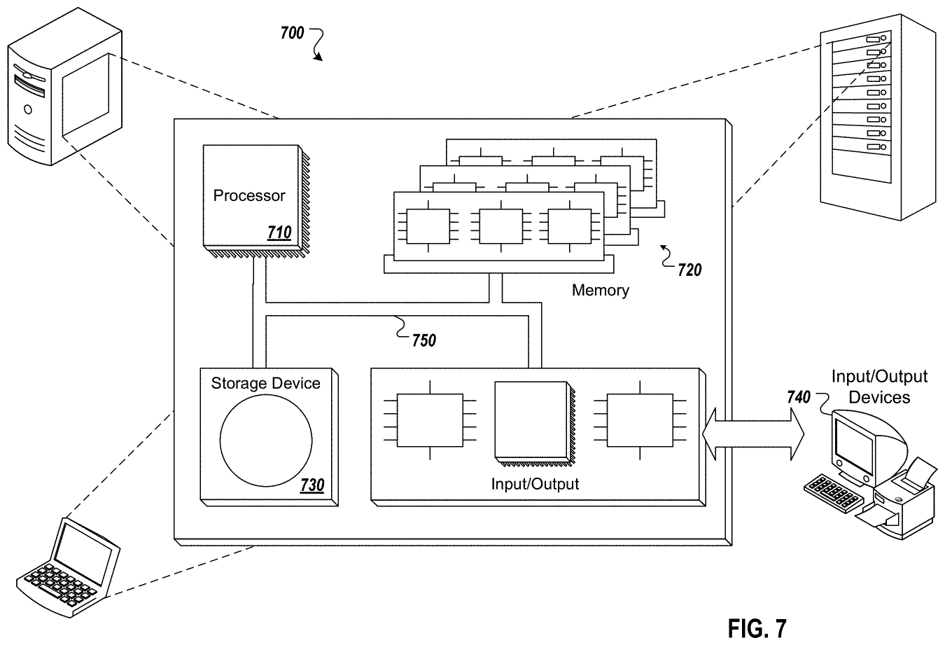

FIG. 7 illustrates a schematic diagram of an example computing system 700. The system 700 can be used for the operations described in association with the implementations described herein. For example, the system 700 may be included in any or all of the server components discussed herein. The system 700 includes a processor 710, a memory 720, a storage device 730, and an input/output device 740. The components 710, 720, 730, and 740 are interconnected using a system bus 750. The processor 710 is capable of processing instructions for execution within the system 700. In some implementations, the processor 710 is a single-threaded processor. The processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. The memory 720 is a volatile memory unit. The memory 720 is a non-volatile memory unit. The storage device 730 is capable of providing mass storage for the system 700. The storage device 730 is a computer-readable medium. The storage device 730 may be a floppy disk device, a hard disk device, an optical disk device, or a tape device. The input/output device 740 provides input/output operations for the system 700. The input/output device 740 includes a keyboard and/or pointing device. The input/output device 740 includes a display unit for displaying graphical user interfaces.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

Embodiments of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. The computer storage medium can be a machine readable storage device, a machine readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) monitor, an LCD (liquid crystal display) monitor, or an OLED display, for displaying information to the user, as well as input devices for providing input to the computer, e.g., a keyboard, a mouse, or a presence sensitive display or other surface. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving, for each type of energy of a plurality of types of energy, data defining a set of parameters related to a capacity of the type of energy for a particular region;
converting, using the set of parameters for each type of energy, the capacity for each type of energy into a common unit of energy;
determining, by evaluating a model using at least on the capacity of two or more of the types of energy and a required amount for each of the two or more types of energy, an operational adjustment to one or more components of an energy consuming system that adjusts energy consumption of the one or more components; and
reconfiguring the one or more components according to the operational adjustment.

2. The method of claim 1, wherein the common unit of energy is joules.

3. The method of claim 1, further comprising generating an energy system curve that represents the capacity of each type of energy of a set of types of energy for the particular region and, for each type of energy, a relationship between invested capital turnover for the type of energy that can be achieved per unit currency and net profit margin for the capacity of the type of energy.

4. The method of claim 3, wherein the model is based on the energy system curve.

5. The method of claim 1, wherein the operational adjustment comprises switching from a first energy source to a second energy source for providing energy to at least one of the one or more components.

6. The method of claim 1, wherein the set of parameters for each type of energy differs from the set of parameters for each other type of energy.

7. The method of claim 1, wherein reconfiguring the one or more components comprises operating a first component of the energy consuming system based on the type of energy selected for a second component of the energy consuming system.

8. The method of claim 1, wherein the model comprises a set of modules configured to determine output parameters that define the operational adjustment to the one or more components.

9. The method of claim 8, wherein the model determines the output parameters based on at least one objective for the model, the at least one objective comprising at least one of minimizing carbon emissions, maximizing margin, maximizing production, or maximizing production without exceeding a carbon emission threshold.

10. The method of claim 1, wherein the operational adjustment comprises a selection of a component from a set of components of the energy consuming system.

11. The method of claim 1, wherein the operational adjustment comprises a selection of a product to be produced by the energy consuming system.

12. A system comprising:
one or more processors; and
one or more storage devices storing instructions that, when executed by the one or more processors, cause the one or more processor to perform operations comprising:
receiving, for each type of energy of a plurality of types of energy, data defining a set of parameters related to a capacity of the type of energy for a particular region;
converting, using the set of parameters for each type of energy, the capacity for each type of energy into a common unit of energy;
determining, by evaluating a model using at least on the capacity of two or more of the types of energy and a required amount for each of the two or more types of energy, an operational adjustment to one or more components of an energy consuming system that adjusts energy consumption of the one or more components; and
reconfiguring the one or more components according to the operational adjustment.

13. The system of claim 12, wherein the common unit of energy is joules.

14. The system of claim 12, wherein the operations comprise generating an energy system curve that represents the capacity of each type of energy of a set of types of energy for the particular region and, for each type of energy, a relationship between invested capital turnover for the type of energy that can be achieved per unit currency and net profit margin for the capacity of the type of energy.

15. The system of claim 14, wherein the model is based on the energy system curve.

16. The system of claim 12, wherein the operational adjustment comprises switching from a first energy source to a second energy source for providing energy to at least one of the one or more components.

17. The system of claim 12, wherein the set of parameters for each type of energy differs from the set of parameters for each other type of energy.

18. The system of claim 12, wherein reconfiguring the one or more components comprises operating a first component of the energy consuming system based on the type of energy selected for a second component of the energy consuming system.

19. The system of claim 12, wherein the model comprises a set of modules configured to determine output parameters that define the operational adjustment to the one or more components.

20. A non-transitory computer readable medium storing instructions that, when executed by one or more processors, cause the one or more processors to perform operations comprising:
receiving, for each type of energy of a plurality of types of energy, data defining a set of parameters related to a capacity of the type of energy for a particular region;
converting, using the set of parameters for each type of energy, the capacity for each type of energy into a common unit of energy;
determining, by evaluating a model using at least on the capacity of two or more of the types of energy and a required amount for each of the two or more types of energy, an operational adjustment to one or more components of an energy consuming system that adjusts energy consumption of the one or more components; and
reconfiguring the one or more components according to the operational adjustment.
